(19) United States
(12) Patent Application Publication
(10) Pub. No.: US 2007/0016587 A1
(43) Pub. Date: Jan. 18, 2007

(54) Scalable peer to peer searching apparatus and method

(75) Inventors: Denis Ranger, Wharton, NJ (US); Jean-Francois Cloutier, Portland, ME (US)

Correspondence Address: JLB CONSULTING, INC.;c/o INTELLEVATE, P.O. BOX 52050, MINNEAPOLIS, MN, 55402, US

(73) Assignee: Mind-Alliance Systems, LLC

(21) Appl. No.: 11/387,988

(22) Filed: Mar. 23, 2006

Related U.S. Application Data
(60) Provisional application No. 60/699,403, filed on Jul. 15, 2005.

(51) Int. Cl. G06F 17/30

(52) U.S. Cl. 707/10

(57) ABSTRACT

A method of searching across a peer to peer network, each peer having searchable content and connected to a plurality of neighboring peers via links, comprises: establishing a contributor pipeline via the links to pass a query around the peers, for contribution of any available result content at respective peers; and establishing a read pipeline via the links to pass contributed results back to a query originator. The read pipeline allows results to be read by any intervening peer that is interested. The pipelines are set up using a subscribe and publish mechanism.

### RELATED APPLICATIONS

The present application claims the benefit of U.S. Provisional Application No. 60/699,403, filed Jul. 15, 2005, the contents of which are hereby incorporated by reference.

### FIELD OF THE INVENTION

The present invention relates generally to electronic network searching and more particularly to a peer to peer querying apparatus and method.

### BACKGROUND OF THE INVENTION

To date there are two forms of search architecture. The first system uses a server, or more typically a server farm, and is scalable. Such systems form the backbone of the Yahoo and Google and other Internet search engines. These systems receive queries using a central server and search through their own indexing of the web. The indexing is regularly updated by crawling the web or by obtaining data via submission forms or in other ways. If the system requires further capacity then new servers are added. New capacity may be required when either the number of searchers increases or the size of the search space increases. For an Internet-based search engine both of these parameters historically shown consistent expansion.

There is a second form of network search server architecture, the peer to peer architecture. In this architecture there is no central server. Rather queries are sent from an originating machine to each of its peers and any results at a given peer are returned to the originating machine. One advantage of a peer to peer search system is that it can be set up without the need for a dedicated server. However the system is not easily scalable. Beyond a certain number of machines the sending of search queries to each machine becomes inefficient and may cause communication bottlenecks. Likewise a large number of returned search results could be problematic for the originating machine.

Another difficulty of searching in peer to peer networks is the ability to execute possibly complex queries in a time-efficient manner. Current peer to peer searching solutions are inadequate for a number of reasons. For example the currently used Gnutella system of Gnutella developers and Gnutella Protocol Development April 2005, relies on a strategy known as query flooding over unstructured P2P networks. This strategy does not scale well.

Another method of peer to peer searching relies on special nodes called super-peers to handle the brunt of the search work (Edutella, JXTA Wolfgang Nejdl, Boris Wolf et al, Edutella, P2P Networking Infrastructure Based on RDF, May 2002). This is generally acknowledged to be overly constraining since the system is limited by the knowledge actually available at the super peers.

A third method of peer to peer (P2P) searching relies on indexing the entire peer to peer knowledge base and assigning particular indexes to specific peers. Such a system may lead to crippling hot spots when a peer is responsible for holding an index, which can be be gigabytes in size, for a particularly popular element of the knowledge base.

As a further challenge inherent in peer to peer searching, the above solutions assume that peers know all about the subjects they publish. Such an assumption is inadequate for a collaboration environment where peers may contribute about similar subjects. Such an assumption would exclude for example entire families of query routing algorithms such as SQPeer.

In summary, the client-server search architecture is generally useful where the network infrastructure can support a dedicated search system. Peer to peer search architecture is used where the infrastructure will not support a dedicated search system. While client-server search systems are scaled through expansion of the server architecture, peer to peer searching poses many unique and challenging problems due to the decentralized nature of the network and the lack of a search server.

There is a widely recognized need for, and it would be highly advantageous to have, a data searching system for peer to peer architectures which is devoid of the above-described limitations.

### SUMMARY OF THE INVENTION

According to one aspect of the present invention there is provided apparatus for searching across an electronic peer to peer network, the network comprising computer system peers, each peer having searchable electronic content and each peer being electronically connected to a plurality of neighboring peers via electronic network links, the apparatus comprising:

a first pipeline establishment mechanism for establishing a contributor pipeline using said links to pass a query to said peers for contribution of any available result content; and

a second pipeline establishment mechanism for establishing a read pipeline via said links to pass contributed results back to a query originator.

According to a second aspect of the present invention there is provided a method of searching across a peer to peer network, the network comprising peers, each peer having searchable content and each peer being connected to a plurality of neighboring peers via links, the method comprising:

establishing a contributor pipeline using said links to pass a query to said peers for contribution of any available result content; and

establishing a read pipeline using said links to pass contributed results back to a query originator.

According to a third aspect of the present invention there is provided a searchable peer-to-peer network, comprising:

a plurality of computer system peers, each peer electronically connected to a predetermined number of nearest neighbors such that a given peer is connected either directly or indirectly to all other peers in the network,

means for establishing a pipeline from a query source peer to all other peers to broadcast a search query; and

means for establishing a return pipeline to feed results of said search query from any one of said other peers to said query source peer.

According to yet another aspect of the invention, there is provided a method of searching an electronic peer-to-peer network including a plurality of peer processors connected by an electronic peer framework and including a peer messaging system, comprising the steps of:

receiving a query including at least an atomic query;

determining if the query is already being searched in the network;

subscribing, if the query is already being searched in the network, using the peer messaging system, to the results of the query;

sending, if the query is not already being searched in the network, using the peer messaging system, the query to the plurality of peer processors.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of described embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWING FIGURES

The invention is herein described, by way of example only, with reference to the accompanying drawings. With specific reference now to the drawings in detail, it is stressed that the particulars shown are by way of example and for purposes of illustrative discussion of embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a diagram illustrating a generalized embodiment of the present invention;

FIG. 2 is a flow diagram illustrating a procedure for searching an atomic query on a peer to peer network according to a described embodiment of the present invention;

FIG. 3 is a flow diagram illustrating a modification of FIG. 2 for a complex query;

FIG. 4 is a block diagram, illustrating an apparatus for carrying out the methods of FIGS. 2 and 3;

FIG. 5 is a diagram illustrating a geometry of a peer to peer network, according to a described embodiment of the present invention;

FIG. 6 is a diagram illustrating processing of a query tree according to a described embodiment of the present invention;

FIG. 7 is a flow diagram illustrating the setting up of a contributor pipeline and a read or consumer pipeline according to a described embodiment of the present invention;

FIG. 8 is a diagram illustrating the setting up of a read pipeline back to a query producer according to a described embodiment of the present invention;

FIG. 9 is a flow diagram illustrating processing of a complex query AQ1, according to a described embodiment of the present invention;

FIG. 10 is a flow diagram illustrating forwarding of a consumer request via an intermediate node Py, according to a described embodiment of the present invention;

FIG. 11 is a tree diagram illustrating the establishment of a read pipeline from a query producer P1 to consumer nodes, according to a described embodiment of the present invention;

FIG. 12 is a flow diagram illustrating buffering in rows to deal with connection nodes removing themselves from the network during query processing, according to a described embodiment of the present invention; and

FIGS. 13 and 14 are state diagrams for nodes involved in forwarding, aggregating or consuming queries according to a described embodiment of the present invention.

### DESCRIPTION OF THE INVENTION

The present embodiments comprise an apparatus and a method for the execution of complex queries across peers in a timely and resource efficient manner. Such is a difficult problem in peer-to-peer networking.

Briefly and as is well known in the art and to the reader, the “Semantic Web” is a W3C standardization project that considers World Wide Web data as intended not only for human readers but also for processing by machines, enabling more intelligent information services. The Semantic Web takes advantage of standardized extensible Markup Language (XML) and RDF schema, and includes semantic data graphing to facilitate searching and other data processing.

The present approach is to use queries, in one embodiment distributed Resource Description Framework (RDF) queries, in a two-phased process as follows:

1) establish a contributor pipeline to get the raw data, then

2) form a reader pipeline to read the results.

Pipelines are created efficiently using a publish/subscribe mechanism, for example the Pastry's Scribe framework described by M. Castro, P. Druschel, A-M Kermarrec and A. Rowstron, Scribe, a lg-scale decentralized application-level multicast infrastructure, October 2002. RDF queries are established in triples: subject, predicate, value, in a manner known to the reader and described below.

In the target environment of the present embodiments, each peer in a networked group shares some of its content with the group. Peers are assumed to be of equal standing, in that no peer is more equal than the others. With that assumption content may be duplicated across peers, to the discretion of the users.

The present embodiments comprise an information sharing platform with a decentralized design that supports bottom-up, community-driven information sharing activities.

The platform uses a P2P infrastructure to create RDF-based knowledge addressable networks. It is assumed that each peer can efficiently access its own content as a semantic web graph. The present methodology has been developed to support:

1. Potentially very large P2P networks. Centralized solutions do not scale, and also run into data ownership issues. Very large communities should be able to share information without a central dissemination point.

2. Distributed RDF knowledge bases. Each peer is a potential source of information/knowledge. RDF is used since it is the World Wide Web Consortium (W3C) standard for knowledge encoding and provides a uniform format for the distributed system. A further reason for concentrating on all peers as equal sources of information is that different peers may hold different pieces of information about the same subject.

3. Structured querying of RDF knowledge bases distributed over large P2P networks. More particularly, querying semantic web information is more involved than merely locating files given one or more of their attributes. Knowledge needs to be extracted out of, or combined from, information spread over a P2P network. Complex queries need to be processed reliably. If there is an answer, it requires finding in the most efficient manner possible. Using the present embodiments the time taken increases only slightly with the number of peers.

The P2P search systems and methods of the present invention have the following features and advantages:

1. No a-priori indexes. There are no special peers that carry indexing of the content of the group. A reason for this is that the ability to perform generic ad-hoc queries without knowing or limiting what the specific queries are implies that any a priori indexing would be mostly guesswork. Furthermore, a scheme that finds results from scratch, coupled to efficient, redundant caching and cache lookup seems more appropriate. Frequent queries are cached effectively as they occur.

2. Read driven. Queries remain active as long as clients are reading from it, and stop when no one cares. Query results are forwarded to clients when they actually ask for them. This avoids the ‘drinking-from-a-fire-hose’ effect of suddenly receiving a flood of results which is beyond the absorptive capacities of the receiving device's buffers.

3. The more, the merrier. Common query results will be cached by more peers in the group, making retrieval of results quicker.

4. Resource thriftiness. Memory, processes and network connections are to be kept within the capability range of each peer. For example, all messages exchanged between two peers will be multiplexed into one connection.

5. Equitable sharing of work. As much as possible, peers should collaborate in performing common searches.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

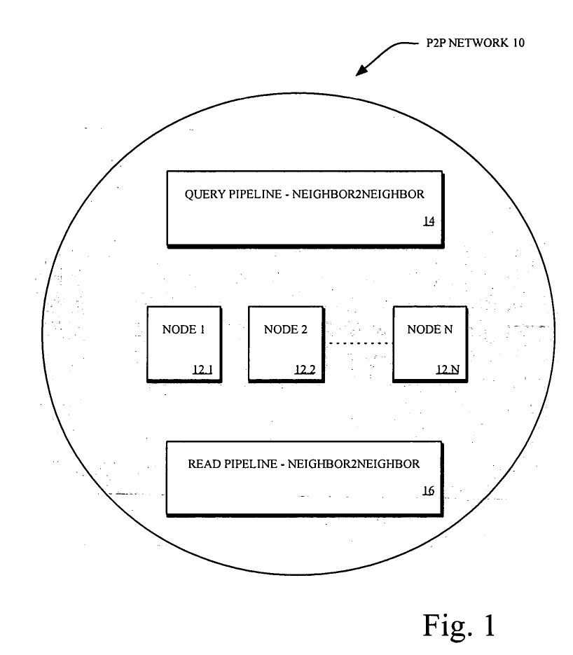

Reference is now made to FIG. 1 which is a schematic illustration showing a generalized embodiment of the present invention. A peer to peer network 10 comprises a series of nodes 12.1 . . . 12.n. Each node is a separate and, within the consideration of the invention, equal computer on the network. The presence of a search query causes the construction of a query pipeline 14 over which the query is passed from one node to each of its neighboring nodes. The presence of a search query further brings about the construction of a read pipeline 16 through which the results are first sent to the querying computer and subsequently any computer interested in reading the results is able to subscribe and receive the results. The read pipeline may also carry out amalgamation of results, as will be discussed in greater detail hereinbelow.

When one of the computers wishes to search for data over the network in accordance with a query it uses a publish subscribe mechanism first of all to subscribe to any read pipeline 16 that might already exist with results of the same query. That is to say it checks the network to see if there is a live query result that corresponds to the desired information. If there is then it does not initiate a new search but simply obtains the results of the existing query. Thus network resources are saved.

If there is no such existing read pipeline then a new query pipeline 14 is constructed which leads directly from the querying peer to each of its nearest neighbors, then from the neighboring peers to their nearest neighbors and so on over the rest of the network. The query is broadcast over the network. A read pipeline 16 is likewise constructed along which results can be accumulated from over the network and sent to the originating machine.

Other machines that subsequently want the same results are able to subscribe themselves to the end of the read pipeline so that they too are able to obtain the accumulated results.

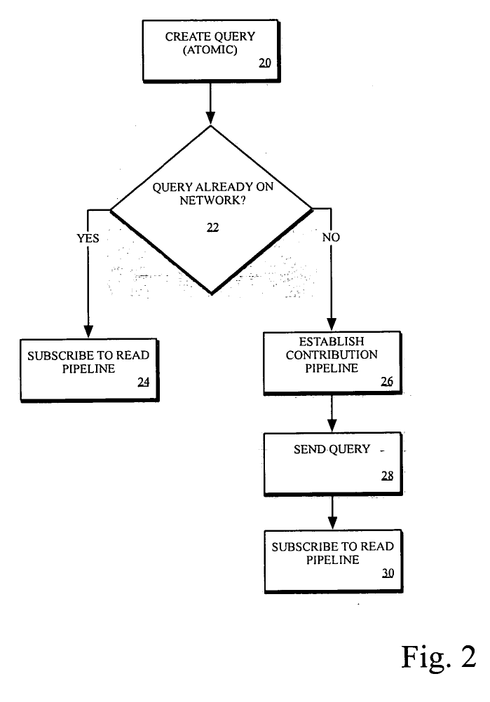

Reference is now made to FIG. 2, which is a flow chart illustrating the procedure described above. The method involves a stage 20 of obtaining a query at one of the peers. The query may be obtained from a user through a user interface or it may be software generated, or obtained in any other way.

The query is an atomic query (AQ), meaning it cannot be broken down into smaller queries. The alternative case of a non-atomic query is discussed later on.

The peer in stage 22 first checks the query against a list of existing read pipelines for which subscription is open. If the query is present then in stage 24 the peer simply subscribes to the read pipeline. If the query is not currently present then the peer establishes a contribution (or query) pipeline in stage 26, sends a query in stage 28 and subscribes to a read pipeline in stage 30.

Each individual peer in the network has searchable data which it preferably configures as a semantic web graph in order to aid searching.

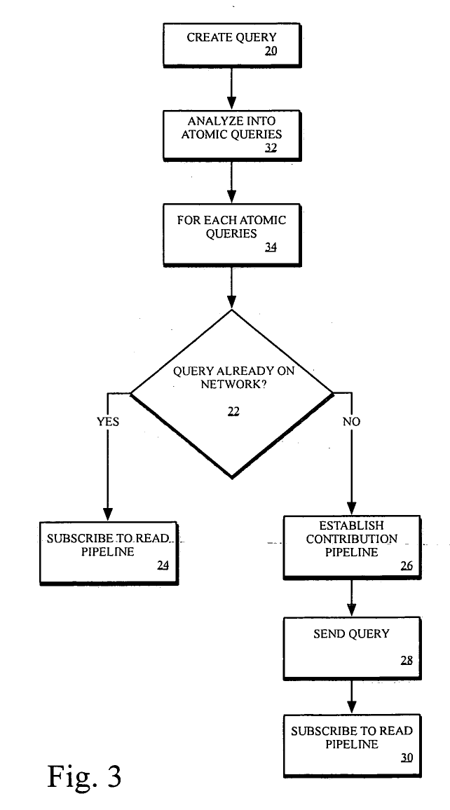

Reference is now made to FIG. 3 which is a variation of FIG. 2 for the case of the query being a complex query. Parts that are the same as for FIG. 2 are given the same reference numerals and are not described again except as necessary for an understanding of the present case.

As shown in FIG. 3 the method further comprises a stage 32 of analyzing the complex query into constituent atomic queries and then pipelines are set up or subscribed to on the basis of individual atomic queries. It will be understood that this process may involved decomposing complex queries first into smaller complex queries, then into atomic queries.

It is noted here that the present disclosure presents a searching system that is as much as possible independent of the content of individual queries and query languages. The issue of analyzing complex queries into atomic queries is very much dependent on the individual queries and the query language being used and is an issue that is well known in the art. Suffice it to say that an OR type query in which one searches for A or B, can be treated as two separate queries, one for A and one for B, the results of which can later be amalgamated to make up the full results. An AND type query, for A and B on the other hand is most likely to be implemented as a single atomic search. The query can carry out a local search for A, and then refine the search by removing any results that do not include B, finally sending only the refined search down the read pipeline.

It will be appreciated that different results are retrieved from different peers and these results may be aggregated over the read pipeline.

In the case of a complex query there is a further stage of aggregating results from the different atomic queries into an aggregated result. This further aggregation is typically, but not necessarily, carried out at the node originating the query.

It will be appreciated that with earlier results remaining on the network it becomes relevant to somehow indicate a length of time for which a result is valid. That is to say how long after a search was originally made should one direct all queries to the previous results and when should one carry out a new search.

In one embodiment a global time to live variable is set based on the kind of data in the network. Thus if the network is for musical content, which does not get updated very often, a time to live of several days would be satisfactory for the entire network. On the other hand a network sharing news information may want to have a time to live variable that is no longer than a few minutes. As a further alternative, individual data items stored over the network may have their own time to live variables. An individual set of results may set its time to live variable according to the time to live variables of the items found. Thus the time to live variable for the search results may be set as the shortest of the retrieved items, or the average of the retrieved items or in any other way. The results are retained for the duration of the time to live variable.

As will be explained in greater detail below, the establishment of the contributor or query pipelines, and of the read piplines are carried out using a subscribe and publish mechanism.

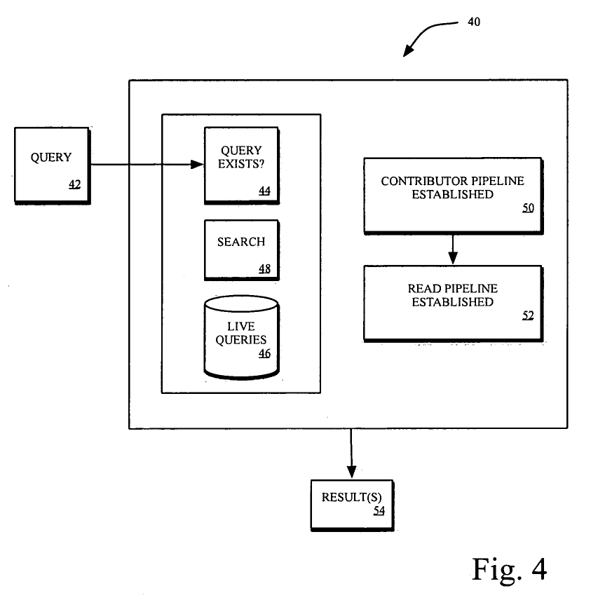

Reference is now made to FIG. 4 which is a block diagram illustrating apparatus 40 for searching across a peer to peer network. As above the network comprises peers, and each peer has searchable content. Each peer is connected to a plurality of neighboring peers via links, and is able to contact all non-neighboring peers in the network by passing messages through the neighboring peers.

Apparatus 40 receives a query request 42. According to the definitions given above the request as received is already in the form of an atomic request.

The apparatus first passes the request through existing query block 44 that either knows or searches through existing queries on the network to see if there are live results for the query currently available. Block 44 may include a register 46 of all current requests and a searching unit 48 that searches the register. If a corresponding query is found to be live on the network then the existing query block simply subscribes the querying node to the query, which in effect means adding the node to the end of the read pipeline of that node.

Following existing query block 44 is a first pipeline establishment mechanism 50. The first pipeline establishment mechanism receives the query from the existing query block if no existing query is found and it establishes a route or pipeline around the network for sending the query around the peers. Peers having data corresponding to the query then contribute the data. The pipeline leads from each peer to its nearest neighbors so that distribution of the query does not pass through any particular bottlenecks.

Apparatus 40 further includes a second pipeline establishment mechanism 52 which establishes a read pipeline over the network links via which the contributing peers are able to pass contributed results back to the query originator. The read pipeline is preferably designed to merge results as they appear, and again makes use of the nearest neighbors of any given peer so that the results can be returned without forming bottlenecks. Also, since the results emerge from numerous paths over the network they do not appear all at the same time, and the querying peer is not suddenly bombarded by large numbers of responses. The read pipeline is further designed so that results 54 are cached at various locations and further peers requesting results from the pipeline are able to subscribe to the pipeline and receive results from the closest cached location.

Using the two pipeline establishment mechanisms defines the query and result propagation paths in advance. This has the advantage of ensuring that propagation makes full use of all neighbor to neighbor links instead of data packets being routed independently. The latter leads to the creation of bottlenecks along favored routes.

Setting Up Pipeline

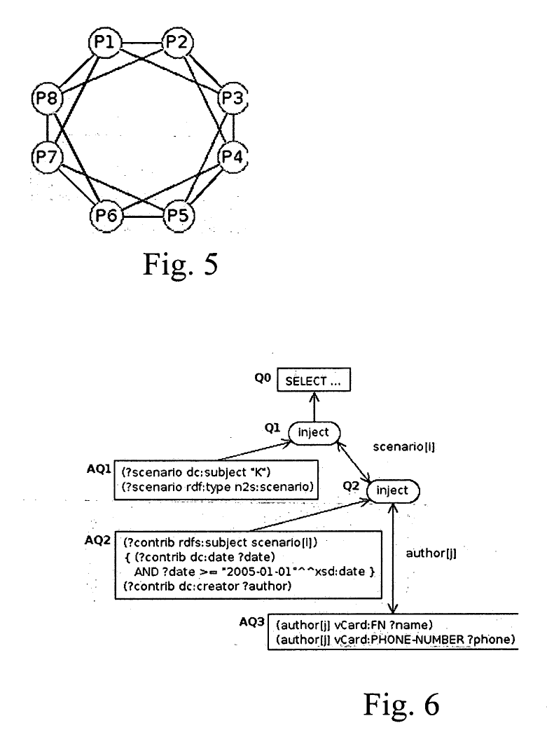

Reference is now made to FIG. 5, which illustrates one construction of a peer to peer network. In the peer to peer geometry of FIG. 5 a series of eight peers P1 . . . P8 are connected together in such a way that each peer is connected to four neighbors. Now let us say that the connections are dynamic, that peers disconnect from the network and new peers connect to the network. A layer is needed that can maintain the connections and always ensure that each peer is connected to a certain number of nearest neighbors.

1) Supporting Functionality

The described embodiments use the Pastry P2P (peer to peer) substrate, which was referred to above, and which provides a scalable, decentralized and self-organizing framework for routing messages from one peer to another, in other words for carrying out routing of messages. Each peer in the network is aware of a small number of its nearest neighbors, four neighbors in the example of FIG. 5. The invention is not limited to the Pastry framework, but will work with any similarly functional structured P2P framework, including, but not limited to: Tapestry, Chord, CAN and others as are known to the reader.

Routing of messages to another peer using the Pastry substrate is efficient, in that the message is sent either to a neighbor closer to the destination, or the target itself, if the target happens to be a neighbor.

FIG. 5 assumes a group of 8 peers, with each peer connected to four others. It will of course be appreciated that other arrangements are possible and in particular, a particular property of Pastry's message routing is that it is massively scalable. Thus, if the 6.6 billion people on earth were peers and each peer is connected to 32 neighbors, reaching any peer from any peer would take at most 9 hops. The maximum number of hops is:
Log₂_{^{c}}(N)−1|
where N is the number of peers and c is the number of connections per peer (c=1, in our example). A typical implementation uses c=4.

The present embodiments explain how to implement an RDF search using specific message exchange over the Pastry infrastructure. It will be recalled that RDF is a standard for storage and retrieval of knowledge. The messaging uses the Scribe functionality which is based on Pastry as discussed above. Scribe offers basic topic publish, subscribe, broadcast and anycast mechanisms. Herein the term “anycast” means the sending of a message to the first subscriber that accepts it.

The present embodiments make use specifically of the following Scribe functionality:
Subscribe A peer may join a topic X. From that point on (and until unsubscribing,) the peer will be able to send/receive message published to that topic by any other peers.
Publish Peers subscribed to a topic may send all kinds of messages to other subscribed peers. The publish functionality is very efficient and scalable.

The Scribe framework does not impose limits as to what kinds of messages can be sent. The present methodology uses the following types of messages:
Anycast A message is sent to the first peer who accepts it, as explained above.
Broadcast A message is sent to all peers in the group (technically a multicast).

Using the Scribe functionality, a peer can subscribe to a topic and from that point, receive messages published by other peers to that topic.

When receiving an anycast message, a peer may ignore the message and pass it along to the next peer, or take the message out of the loop and process it.

When receiving a broadcast message, the peer processes the message and passes it along. Scribe minimizes the number of network hops and maximizes the proximity of communicating peers when performing publish and subscribe operations. In general the broadcast mechanism is used for the query pipeline, and the anycast mechanism is used for the read pipeline, in which the messages are sent to any subscribed machine, as will be explained below.

2) The Pipeline

When the Scribe functionality is used in the present embodiments and in the setting up of pipelines, each unique query is first made into a topic. It will be recalled that if the query is not unique then the query producer simply joins the results queue and no new query is launched.

In addition, all peers are required to subscribe to a generic broadcast topic.

Now, the first phase in the operation is to set up the data pipeline. For sending out the query the messages are simply broadcast, but only if necessary. Broadcast messages are sent from each peer to its neighbors, in as many hops as necessary to cover the network.

Now, it may be that the query has already been answered, in which case the querying machine only needs to connect itself in a queue to the originating query machine. If the query is a new query then the querying machine has to set up a return pipeline, so that all sources of data are able to return search results to it.

The setting up of the forward pipeline simply uses the broadcast functionality to send the atomic queries to all peers in the network. The return pipeline is based on subscription, and anycast messages are used so that the return data is sent throughout the network and retained by any machine that wants the data. That is to say the results are sent to any subscribing machine, of course principally including the query producer. The querying machine or query producer subscribes to the topic of the query and so do any other machines that are interested in the results.

It will be understood that while the invention has been shown and described with respect to the Pastry Scribe system, Scribe is a straight-forward publication/subscription system and any publication/subscription mechanism operable in a P2P network will suffice.

Queries

Having discussed the pipeline it is now possible to consider the queries themselves. Typically a user enters a search query into a search interface. In some cases the raw data entered by the user forms the search query. In other cases the search data is actively formulated into the final query by software. In other cases the query may originate from software.

Queries are treated as two types, simple or atomic queries on the one hand and complex on the other hand. For the present purpose, an atomic query is a simple, stand-alone query that all peers can execute on their local contents, without resorting to results from other peers.

The original queries are translated into trees of either atomic or complex sub-queries. The atomic query is effectively, a leaf at the end of a search tree that describes a full complex search. A complex query uses results from other queries to produce its results, either by aggregation, filtering or calculation.

In the described embodiment, queries are expressed in the SPARQL dialect, disclosed in Eric Prud'hommeaux, Andy Seaborne et al., “SPARQL Query Language for RDF”, April 2005,. However, the present discussion refers to the general case and only assumes that queries can be decomposed into trees of smaller queries.

Reference is now made to FIG. 6, which is a simplified flow chart illustrating processing of a complex query that finds names and phone numbers of all 2005 contributors to scenarios containing the “airport” keyword. The process makes use of the Dublin Core and vCard vocabularies, disclosed in the Dublin Core Metadata Initiative, “Dublin Core Metadata Element Set, Version 1.1: Reference Description”, December 2004, http://dublincore.org/documents/dces/and Renato Iannella, “Representing vCard Objects in RDF/XML”, February 2001, http://www.w3.org/TR/vcard-rdf.

This query would translate to the query tree shown in FIG. 6.

The example includes a complex query, which is treated as a major query including a number of scenarios. The inject query Q₁ takes the scenarios found by AQ₁ and for each of them, runs a separate Q₂ query (and similarly for Q₂ and AQ₂, etc.).

For the purpose of the present example, atomic queries are limited to the 7 RDF canonical triple queries.

(?s?p?v) Find all RDF triples on a peer.

(?s?p V) Find any RDF triple that has V for its value.

(?s P?v) Find any triple using predicate P.

(?s P V) Find triples having predicate P and value V.

(S?p?v) Find all properties and objects related to subject S.

(S?p V) Find triples of subject S having value V for any predicate.

(S P?v) Find values of subject S attached to predicate P.

Since all peers can execute arbitrary complex queries, the exact distinction between atomic and complex queries is somewhat fuzzy or uncertain. It is not usually feasible to determine just by looking at a query, if it should be run locally on each peer. This depends on whether objects are stored as a whole on each peer, or if pieces of objects are spread out on different peers and is dependent on the application being built on top of the overall search framework.

The described embodiment addresses the ambiguity between atomic and complex queries by co-locating predicates from designated namespaces, in this example dc, vCard, rdf and rdfs. Co-location of predicates achieves the result that, for the same subject, all predicates from a co-located namespace are available on the same peer. If a peer knows of author X, it will also know all other vCard predicates. A peer copying an author's information will also copy all the associated predicates.

It will be understood by the reader that while the invention has been shown and described with respect to RDF queries, any search function will suffice that enables: i) queries to be decomposed into sub-queries for independent execution, and ii) sub-query results to be re-composed or aggregated. Query languages that will suffice include, but are not limited to: the various dialects of the SQL query language, the various RDF query languages such as SPARQL, RDQL and SeQRL, and other structured query languages as will be known to the reader.

Result Set Properties

Reading the results from a query is an ongoing process. Imagine a slow laptop processing thousands of results coming from a neighbor. While this processing is taking place, peers may come and go, data on contributing peers may have changed, and so on.

Replicating the situation of a relational databases isolation levels in an P2P environment is not easily achieved. Instead, a few indicators as to the quality of the data it is reading are preferably provided to the result consumer. It is up to the consumer to decide what to do when those properties change. Actions may include restarting the query, providing some visual feedback to the users, etc . . .

The following is a list of flags or indicators that can be used to describe the status of the data.

validity: True if results read so far have not been changed. This may be set to false when a peer has already contributed some result to the result set (RS), and it knows for a fact it has changed since.

snapshot: True when a peer has contributed values that do not have a permanent validity. This is the case for example with sensors, whose values change constantly over time. It is an indication to the users that no matter how many times they restart the query, they will never get a definitive answer, merely a snapshot.

invalidation: Time at which the result set becomes invalid.

expiration: Time at which the result set should either be re-queried or removed from caches. In an example this may be defined as the earliest expiration time of all data used to produce the result set.

liveness: True if new results may still be added to the result set, if the user waits long enough. Live queries are analogous to spreading a spider web to catch any new data that comes along while they are still active.

thoroughness: The query must be executed by all peers. Used by some system-wide queries.

completeness: True if the result set includes the first element. As readers go through results set, a peer may opt to lose results that have already been read by all consumers (a moving window). Only peers with a complete result set may accept new consumers.

Any of the above flags can be specified as part of a query.

Method of Implementation

The method of implementation of the described embodiments can be summarized as follow.

When a peer needs to perform a query it carries out the following:

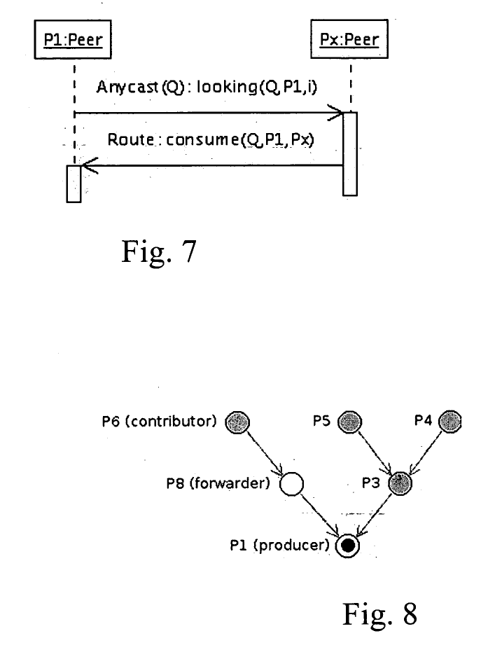

1. It first looks for another peer that is either looking for or already has the result of the query. If one is found, the peer joins the consumer pipeline tree rooted at a producer of the query results. FIG. 7 shows the result pipelines established when a peer (P1) performs a query.

2. When processing a non-atomic, or complex query, the peer breaks the non-atomic query into smaller queries or sub-queries and repeats the algorithm with the smaller queries, either dividing up the queries further, joining consumer trees of the subqueries if they are already on the network or processing the queries if they are both new (not present on the network) and atomic.

3. When processing an atomic query, the peer establishes a producer pipeline tree with the current peer as a root.

4. When consumers ask for results, the producing peer will read/combine results from the produce pipeline and forward the results to the consumers (aggregation).

FIG. 8 is a simplified diagram illustrating producer and consumer pipelines that result from node P1 performing a query. Gray nodes are contributors to query Q; white nodes are forwarders; and black nodes are consumer of the results integrated by P1.

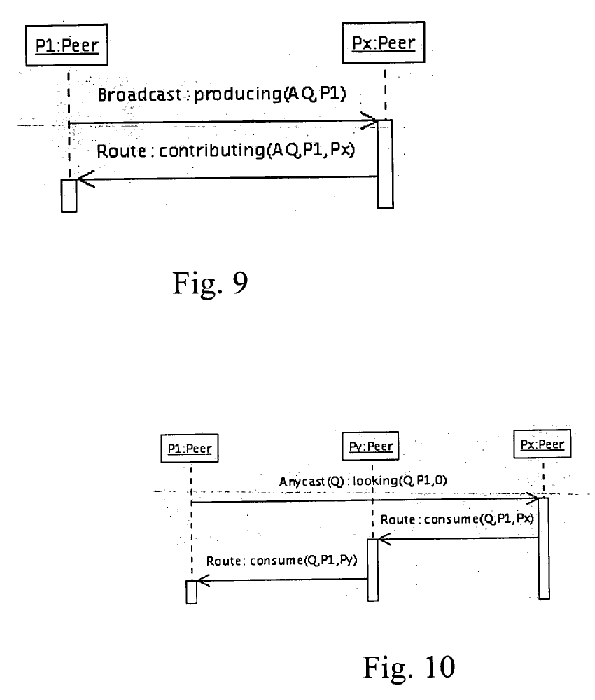

FIG. 9 is a simplified flow diagram illustrating an exemplary decomposition of a query into atomic and complex sub-queries. An inject query Q1 takes the scenarios found by atomic query AQ1 and for each of them, runs a separate Q2 query. The Q2 query is itself treated in the same way, thus Q2→AQ2.

Lookup

As explained, the first phase of the algorithm involves looking around in the group for a peer that already knows (or is about to know) the results of the query of interest. This step is necessary in order to avoid redundant queries as much as possible. Some redundancy might still happen due to network outages or delays but should be kept to a minimum. At the end of the lookup stage, peer P1 has a result set RS(Q) ready for processing. Results either come from another peer or may be added by a background thread performing the query.

Pseudo-code for query lookups
state(Q)=looking
Subscribe to Scribe topic T(Q):
Nodes either looking for or already having the answer to Q.
RS(Q)=new empty result set
Setup a wake-up timer for RS(Q)
Anycast to T(Q) the message:
looking(Q,P1,0):
P1 wants RS(Q) starting at index 0
Return RS(Q)

Nodes preferably remain subscribed to the topic as long as they are interested in Q. Subscribers to the topic may be required to help in producing results. Such a requirement ensures that any given peer takes part in any queries that it originates, directly or indirectly. The requirements avoids free-loading, in other words a rogue member of the group cannot flood the group with queries without involving the resources of its own peer.

Aggregators are nodes in the pipelines. Reading data from the output of an aggregator either obtains data from one of its input nodes or causes the aggregator to wait until new data is available. The aggregator may for example wait for a new input connector to be added. New connectors are added when consume messages are received. Thus the aggregator does not waste resources on aggregating currently unwanted data.

The method of aggregation is implementation-dependent and may be for example, breadth-first, depth-first, local-first (nearest results treated first), etc. A timer is preferably set to stimulate P1 (the query producer) after a certain wait period of inactivity. Upon receiving the stimulation, or waking up, if no new connectors have been added to RS(Q), P1 may perform the query itself, whether atomic or complex, as will be described in greater detail hereinbelow.

The anycast mechanism referred to above ensures that messages are delivered to the closest peer that accepts them. In the present case the message is accepted by the closest peer that is either a forwarder or a producer.

When considering an anycast message, a peer may either decide to process it or to route it to another peer. The messages in Table 1 below ensure (as much as possible) that at most one node will carry out or process any query. The procedure listed below in table 1 provide a “more-powerful” operator that designates one of the peers (the most powerful) as a volunteer to do the processing if many peers are making the same query at the same time. Note that another heuristic other than more powerful, such as younger, older, less-busy, etc could be used instead to select a volunteer.

TABLE 1
“More Powerful” Operator

```
if ( ( state(Q) == “looking”
        && Pₓ more-powerful than P₁)
      || state(Q) == “producing”
      || state(Q) == “forwarding” )
  if i >= first index of buffer
  Route to P₁:
    consume(Q,P₁,Pₓ):
      P₁ may get RS(Q) from Pₓ
```

Origin Target Message Pseudo-code

1. When receiving consume(Q,P₁,Pₓ) on T(Q), P₁ will perform the pseudocode in Table 2:

TABLE 2
Pseudo Code for routing messages

Px P1 consume(Q,P1,Px) if state(Q) == looking,
RS(Q) += RS(Q) from Px
state(Q) = forwarding
disable timer for RS(Q)
else
ignore message

With reference to FIG. 10, the pseudocode in Table 2 adds a new connector from Pₓ to the RS(Q) aggregator on P₁. When receiving multiple consume messages resulting from the lookup message (or after deciding to become a producer), subsequent consume messages are simply ignored.

Referring now to Table 3 and when routing consume(Q,P₁,Pₓ) on T(Q) towards P₁, P_{y} performs the following pseudocode:

TABLE 3
Pseudocode for Py when routing consume messages

Px Py consume(Q,P1,Px) if state(Q) == looking
|| state(Q) == initial,
RS(Q) += RS(Q) from Px
state(Q) = forwarding
disable timer for RS(Q)
route consume(Q,P1,Py)
to P1

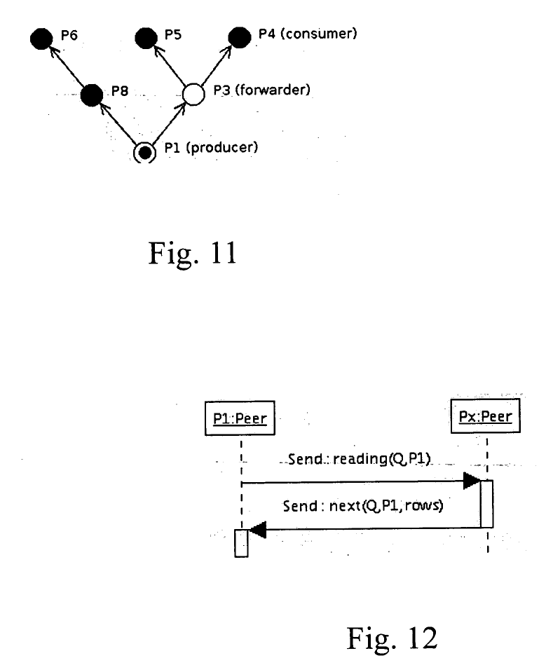

P_{y} thus becomes a forwarder of RS (Q) if it is a midpoint between P₁ and Pₓ. When many peers are executing the same query, the lookup stage preferably sets up a consumer tree rooted at the producer peer. For example, if peer P₁ was the first to run the Q₀ query, and then P₄, P₅, P₆ and P₈ did a lookup of Q₀, the consumer tree of FIG. 11 would have been established.

Referring now to FIG. 11, a consumer tree as shown is established in 2k log₁₆(N) time where k is the average send message time and N is the number of peers in the network. If the average time it takes to send on message to a neighbor is 30 ms in a group of 60000 peers, the above tree would be created in about 238 ms.

Atomic Queries

Atomic queries are simple, stand-alone queries that every peer can apply to its own local content, without requiring queries to other peers. A peer that originates a new atomic query (P1) firstly broadcasts the fact to other peers in the group. When receiving the broadcast, peers (including P1 itself) contribute if they have original content to contribute. The contribution is either instantaneous, or can be continuous for as long as the query is live, depending on the type of query. That is to say, a continuous version of the query is provided in which a time to live option is added to the query to enable an originator to be able to wait for new results as they happen.

TABLE 4
Pseudo-code for atomic(AQ) performed by peer P1

Broadcast on T(*):
producing(AQ,P1):
P1 needs RS(AQ)

If the time to live option is used then the pseudo-code in table 4 is invoked after the time out has expired.

Table 4, as well as earlier tables, refers to a parameter RS(AQ). The RS (AQ) parameter is created during the lookup phase referred to above. The parameter sets up P₁ as a producer of results for the query. Essentially, P₁ is telling every peer in the group to send it their individual results for AQ and will act as a magnet for collecting all the results.

The following explains the behavior of participating peers as they receive messages from neighboring peers.

1. When receiving producing(AQ,P₁), Pₓ performs the following pseudocode:

```
if AQ(Pₓ) size > 0
    or AQ is live,
  RS(AQ) += RS(AQ|Pₓ)
  state(AQ) = “contributing”
  if Pₓ != P₁,
    route to P₁:
      contributing(AQ,P₁,Pₓ) =
      Pₓ can contribute to AQ.
        P₁ needs to know
```

In other words, Pₓ will contribute if it has something original to contribute or if the query is live, as explained above. FIG. 9 illustrates the current case.

Incidentally, if Pₓ=P₁ and P₁ can contribute to AQ, this will effectively add the local results to RS(AQ).

When the query is of the kind that only cares about finding what is out there now, the contributor tree is preferably trimmed down to peers that can actually provide results. Otherwise the query remains live at all peers so that later-arriving results are processed.

When a new peer joins the group, it preferably asks for and contributes to any live atomic queries known about by its new neighbors. Forcing new peers to contribute to known live atomic queries in this way ensures that no potential sources of results are ignored.

If, on the other hand, a contributing or forwarding peer intentionally or accidentally leaves the group, lower level peers preferably become aware of the fact, typically using Pastry's built-in mechanisms and re-send the contributing message, thereby repairing the tree with minimal losses. Typically all that may be lost is the unprocessed data in the buffer of the peer that left. A “polite departure” protocol ensures that the remains of a peer's buffer have been sent upstream before the respective peer leaves the network.

TABLE 5
Messages involved in processing an atomic query AQ

Origin Target Message Pseudo-code
P1 Px producing(AQ,P1) if Px can contribute to AQ
|| AQ is live,
RS(AQ) += RS(AQ) from Px
state(AQ) = contributing
if Px != P1,
route to P1:
contributing(AQ,P1,Px):
Px contributes to AQ,
tell P1
Px P1 contributing(AQ,P1,Px) RS(AQ) += RS(AQ) from Px
Px Py contributing(AQ,P1,Px) RS(AQ) += RS(AQ) from Px
if Px != Py,
route to P1
contributing(AQ,P1,Py)

When receiving contributing (AQ,P1,Px), P1 preferably performs the following pseudocode:
RS(AQ)+=RS(AQ|Px)

A connector from Px is preferably added to P1's result aggregator. When forwarding contributing (AQ,P1,Px), Py will do the following:
RS(AQ)+=RS(AQ|Px)
if Px!=Py,
route contributing(AQ,P1,Py) to P1
Py will become a forwarder if it is between P1 and Px.

After time 4klog₂_{^{c}}(N)+AQ₀ where AQ0 is the maximum time any peer would take to determine if it has data to contribute to AQ, a contributor tree will be established. For example, if P3 to P6 had something to contribute, the following tree would be constructed (if the query wasn't live): See FIG. 8 above.

If a live query had been specified, the above tree would have all peers in the group as contributors.

Complex Queries

A complex query (QC) is a non-leaf node in a query tree. Typically, the complex query combines the results of sub-queries in some way.

TABLE 6
Pseudo-code for complex(Q)

state(Q) = “producing”.
QC = new Q-dependent sub-stream aggregator
RS(Q) += QC.
For each complex sub-query SQi,
QC += complex(SQi)
For each atomic sub-query AQi
QC += atomic(AQi)

In table 6 one of the nodes is referred to as a sub-stream aggregator. The sub-stream aggregator is a query-specific consumer of the result sets of the sub-queries. In the present example an inject query would take each result of another query and use it as a parameter to another query, combining all of those results as output.

An optional optimization step at this point would be to designate a volunteer from subscribers to T(Q) to perform the sub-queries. This would introduce another 2k log₁₆(N) of overhead, but has the advantage of improving the distribution of the query processing.

The volunteering is preferably only carried out when the current peer is overworked, say in terms of how many active queries are being performed.

Setup time of the consumer sub-trees may be as follows:

$$cq ( Q ) = {\sum }_{i = 1}^{SQ} {SQ}_{i} + {\sum }_{j = 1}^{AQ} {AQ}_{0 j} + 2 k \times ( 2 AQ + 1 ) \times {log}_{{2}^{c}} ( N )$$

where:

CQ is the number of complex sub-queries,

AQ is the number of atomic sub-queries,

CQᵢ is the overhead for creating the i^{th} complex sub-query and

AQ₀ⱼ is the maximum time any peer would take to figure out if it can contribute to the j^{th} atomic sub-query.

The resulting set up time is still of the order of C log₁₆(N), where C depends on the complexity of the query, or in other words on the depth of the query tree.

The previous formula also assumes that P₁ produces all the sub-queries, one after the other, in fact a worst case scenario, since it assumes that none of the atomic queries had results available on the network. In reality, some lookups succeed and some sub-queries are found to be produced by other peers, improving the setup time from the point of view of P₁. In the present example, in a group dealing mostly with scenarios, it is likely that the results of sub-query AQ₁ (find all scenarios) would already be available to the group.

Reading Results

Once the tree pipelines have been established, the peers preferably read results from neighboring peers. Results are read in a similar fashion whether a consumer is reading from a producer/forwarder, or a producer is reading from a contributor/forwarder.

The system preferably ensures that each peer in a tree buffers its results, by reading X results at a time and making sure that the buffer is kept full as much as possible. Such use of buffering preferably optimizes the flow of data through the pipeline.

It is also the responsibility of participating peers to remove duplicate results from within the limits of their own buffer. This too helps to limit the quantity of data.

The following function is performed when a consumer reads data from a pipeline:

TABLE 7
Consumer Reading Data From a Pipeline

```
next(RS(Q)) --> row of results:
  If not at end of buffer,
    return an entry from buffer
  forall incoming connectors C in RS(Q)
    (in parallel):
    while C exists
        && there is no entry
            from C in the buffer
        && we are not already
            waiting for C
      put rows from next(C) in the buffer
      If no result available,
        wait for new results,
          or user cancel.
```

Reference is now made to FIG. 12 which illustrates the procedure when incoming connectors in an aggregator disappear unexpectedly as peers leave the group, as discussed briefly above.

1. When reading a partial result set for query Q from Pₓ, P₁ preferably does the following:

Send to Pₓ (an immediate neighbor):
reading(Q,P₁):
Send P₁ the next results from RS(Q)
waiting(Q,Pₓ)=true
   2. When receiving reading(Q,P₁), Pₓ preferably does the following:
Send to P₁:
next(Q,Pₓ,rows)=
Here is next batch of rows for Q according to Pₓ
   3. When receiving next(Q,Pₓ,rows), P₁ preferably does the following:
Add rows to buffer
waiting(Q,Pₓ)=false

Adding of rows to the buffer is illustrated in FIG. 12. The time it takes to read R rows of results from the pipeline will of course be proportional to R, the bandwidth of the peer and the distance from the producer of the result. However, if care is taken to ensure that the pipeline is kept as full as possible, the throughput of data should be fairly constant, once the data reaches the consumer.

Peer State Transitions

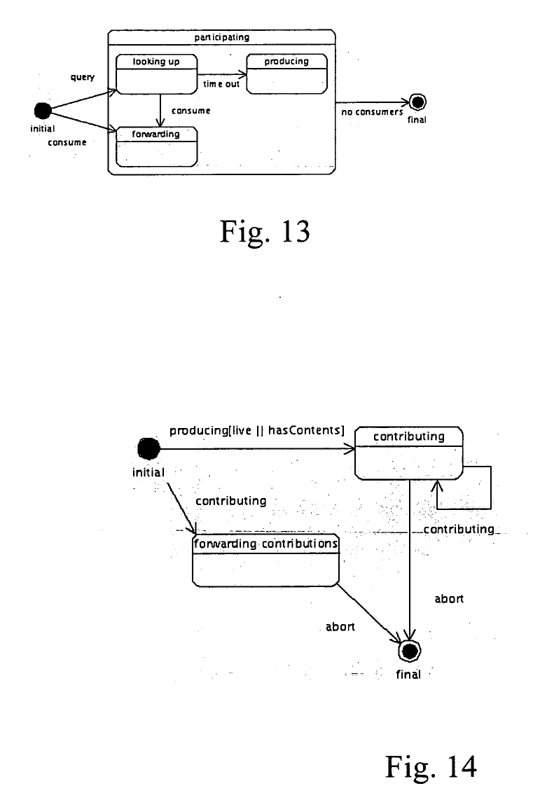

Reference is now made to FIG. 13, which is a state diagram that captures the state transitions that a peer will go through when processing a query.

Peers keep different state information for each query they participate in, whether by consuming, producing or forwarding query information.

FIG. 13 refers to the handling of both complex and atomic queries.

As shown, once a peer participating in a query detects that there are no consumers left, it can decide to forget about looking up, forwarding or producing results. However, if the peer is not busy or overused, it may opt to hold on and cache the results for as long as desired.

Reference is now made to FIG. 14, which is a state diagram illustrating contributing to atomic queries.

The producer of an atomic query preferably sends an abort message when no more consumers are available. A forwarder routes the message upstream to its contributors.

Error Recovery

A peer can usually recover from the loss of a forwarder in the consumer tree by reconnecting to the tree with its current position as an index. If this lookup fails, which may mean that the producer has failed, then the peer may opt to restart the query. Such an option is particularly attractive if its buffer still contains the first element in the results set. Duplicate results are ignored and the query preferably resumes. Another possibility is to restart the query entirely. As mentioned before, the contributor's tree repairs itself in these circumstances.

General

The methodology described herein can be made to apply self-tuning to the searching abilities on the peer to peer network. Such self tuning can be made available by forcing the peers to maintain and make available certain connection statistics. Certain parameters can be made available dynamically by using the search query system itself. Thus a live query or an equivalent can watch all the peers on the network and dynamically compute the N and k values needed for calculation of the optimal wait period for the lookups.

TABLE 8
Pseudo code for a live query for dynamic self tuning of network.

```
SELECT count(?peer), average(?k)
WHERE
  (?peer rdf:type n2s:peer)
  (?peer n2s:timing ?k)
```

A pseudo code that can support such dynamic tuning is shown in Table 8. The N and k values can be initialized to some reasonable values, say values specific to a slow and a large network.

There have thus been provided new and improved methods and systems for facilitating searching in peer-to-peer networks, the invention providing significant advantages over the prior art. The methods and systems of the present invention are resource thrifty and require no a priori indexing. The invention shares work equitably across peers within a network, with common queries being stored by more peers, making result retrieval faster. Queries remain active only for so long as they are actually being used by clients and forwarded only to clients actually requesting them. The invention is thus seen to provide useful, scalable, efficient searching in a typically challenging peer-to-peer network environment, solving many of the problems heretofore encountered.

It is expected that during the life of this patent many relevant devices and systems will be developed and the scope of the terms herein, particularly of the terms “peer to peer network”, “query language” and “query” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcom-bination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of searching across a peer to peer network, the network comprising peers, each peer having searchable content and each peer being connected to a plurality of neighboring peers via links, the method comprising:
establishing a contributor pipeline using said links to pass a query to said peers for contribution of any available result content; and
establishing a read pipeline using said links to pass contributed results back to a query originator.

2. The method of claim 1, further comprising rendering said contributed results available to any peer in addition to a query originator using said read pipeline.

3. The method of claim 1, further comprising configuring each peer in said network to configure its own content as a semantic web graph, thereby to render said content searchable.

4. The method of claim 1, wherein said query is either an atomic query or a complex query comprising a plurality of atomic queries, the method further comprising analyzing said complex query into constituent atomic queries.

5. The method of claim 4, further comprising establishing a separate contribution pipeline for each atomic query.

6. The method of claim 1, further comprising determining whether a given query is already present on said network and if so, then using a corresponding read pipeline for the given query to obtain results.

7. The method of claim 6, wherein said query is either an atomic query or a complex query comprising a plurality of atomic queries, the method further comprising:
analyzing said complex query into constituent atomic queries; and performing said using and determining steps for each atomic query.

8. The method of claim 1, further comprising aggregating results from different peers.

9. The method of claim 1, further comprising:
analyzing a query into atomic queries for separate treatment; and
aggregating results from respective atomic queries into an aggregated result.

10. The method of claim 1, further comprising retaining results on at least one peer connected to said read pipeline for a duration determined by a lifetime associated with data items of said results.

11. The method of claim 6, further comprising establishing said contributor pipeline when it is established that a given query is not present on the network.

12. The method of claim 1 further comprising sending a query along said contributor pipeline and receiving results from said read pipeline.

13. The method of claim 1, wherein said establishing said contributor pipeline is carried out using a subscribe and publish mechanism.

14. The method of claim 1, wherein said establishing said read pipeline is carried out using a subscribe and publish mechanism.

15. The method of claim 14, wherein interested peers are able to read data from said read pipeline by subscribing thereto.

16. The method of claim 1, wherein said query is a search query for searching through data to contribute data matching said query.

17. The method of claim 1, wherein said query is a dynamic query, which continues to gather results newly available from peers until a predetermined expiration time.

18. The method of claim 17, further comprising using said dynamic query to obtain optimization statistics from said network to optimize timings within said method.

19. Apparatus for searching across an electronic peer to peer network, the network comprising computer system peers, each peer having searchable electronic content and each peer being electronically connected to a plurality of neighboring peers via electronic network links, the apparatus comprising:
a first pipeline establishment mechanism for establishing a contributor pipeline using said links to pass a query to said peers for contribution of any available result content; and
a second pipeline establishment mechanism for establishing a read pipeline via said links to pass contributed results back to a query originator.

20. A searchable peer-to-peer network, comprising:
a plurality of computer system peers, each peer electronically connected to a predetermined number of nearest neighbors such that a given peer is connected either directly or indirectly to all other peers in the network,
means for establishing a pipeline from a query source peer to all other peers to broadcast a search query; and
means for establishing a return pipeline to feed results of said search query from any one of said other peers to said query source peer.

21. A method of searching an electronic peer-to-peer network including a plurality of peer processors connected by an electronic peer framework and including a peer messaging system, comprising the steps of:
receiving a query including at least an atomic query;
determining if the query is already being searched in the network;
subscribing, if the query is already being searched in the network, using the peer messaging system, to the results of the query;
sending, if the query is not already being searched in the network, using the peer messaging system, the query to the plurality of peer processors.

22. The method of claim 21 wherein the framework is a Resource Description Framework and the messaging system is a Pastry Scribe messaging system, the step of subscribing comprising transmitting an anycast message and the step of sending comprising transmitting a broadcast message.

23. The method of claim 21 wherein the query is a complex query including multiple atomic queries and further including the steps of:
separating the complex query into multiple atomic queries; and
performing the steps of determining, subscribing and sending for each of the multiple atomic queries.
